(19) United States
(12) Patent Application Publication
(10) Pub. No.: US 2012/0075112 A1
(43) Pub. Date: Mar. 29, 2012

(54) DISPLAY SYSTEM AND DISPLAY APPARATUS

(75) Inventor: Göran Sundholm, Tuusula (FI)

(73) Assignee: MARIMILS OY, Vantaa (FI)

(21) Appl. No.: 13/375,409

(22) PCT Filed: Jun. 3, 2010
(86) PCT No.: PCT/FI2010/050453

§ 371 Date: Nov. 30, 2011

(30) Foreign Application Priority Data
Jun. 8, 2009 (FI) 20095636

(51) Int. Cl. G08B 5/00

(52) U.S. Cl. 340/691.6

(57) ABSTRACT

Display system for guiding, advising or evacuating, in which system people are guided, advised or warned with display means, such as with display apparatuses, which display apparatuses comprise information, such as images or signs. The display apparatus (1) comprises a display panel (2), which is an e-paper display, such as an electrophoretic display panel or a display panel of that type, for which a lighting arrangement is arranged, which lighting arrangement comprises a light source (3) and a photoconductor layer (4) arranged on the display surface of the display panel or in front of it, which photoconductor layer is fitted to conduct the light of the light source to the display surface of the display panel. The invention also relates to a display apparatus.

### BACKGROUND OF THE INVENTION

The object of the invention is a display system as defined in the preamble of claim 1.

The object of the invention is also a display apparatus as defined in the preamble of claim 13.

The invention relates generally to an information display system and more particularly to an emergency exit display system.

Different systems are known for guiding people in situations of danger, such as in fire situations, to the emergency exits of buildings or vessels. These are various visual ways to mark the desired routes, such as lightings of emergency exit routes, or otherwise, e.g. emergency exit routes marked with reflective paint or tape.

Emergency exit routes are generally marked with display apparatuses that contain an illuminated image. The illuminated image can be e.g. an arrow or a diagrammatic sketch of a running person. In addition, a number of other images are used along an emergency exit route.

In many applications, such as in hotels or passenger ships, there are specified emergency exits in emergency situations, which people should follow in evacuation circumstances. On the other hand, in a fire situation a pre-defined emergency exit may be impossible owing to the location of the fire, in which case prior-art solutions might guide in the wrong direction or even towards the fire.

Solutions are known in the art wherein an image can be changed, e.g. by illuminating only one of the ready images contained in a sign.

Emergency exit displays that indicate a direction are also known in the art, but the direction display in question shows only one direction. Solutions are used in dynamic emergency exit route guidance that comprise a number of displays/images, wherein the display/image in the direction of which guidance is given is illuminated, and the displays/images in the direction of which guidance is not given are extinguished. This is often a problem because the lighting of the display typically requires electric current and it would be good if the display also operated in situations in which electric current is not available for some reason. Another problem is the space requirement, because the placement of many displays/images comprising fixed images takes up space and they become expensive.

The aim of the invention is to achieve a new type of solution, by means of which the problems of prior art can be avoided.

### BRIEF DESCRIPTION OF THE INVENTION

The invention is based on a concept wherein a display apparatus is used in a display system, which display apparatus comprises electronic paper (e-paper; e-ink) as a display element, and which comprises means for illuminating the electronic paper.

The display system according to the invention is mainly characterized by what is presented in claim 1.

The display system according to the invention is also characterized by what is presented in claims 2-12.

The display apparatus according to the invention is mainly characterized by what is disclosed in claim 13.

The display apparatus according to the invention is also characterized by what is presented in claims 14-24.

The solution according to the invention has a number of important advantages. By using the display apparatus, in which electronic paper is used as a display element, in a display system, a very inexpensive and operationally reliable dynamic display system is achieved. The display apparatus consumes little energy, the display panel only when its optical state is changed. By using, according to the invention, a lighting arrangement in the display apparatus, a very effective and attention-catching display apparatus is achieved, which can be admirably applied in different emergency exit guidances. With respect to prior-art dynamic display solutions, such as liquid crystal displays, the energy requirement of a display panel based on electronic paper is extremely small. Additionally, the contrast of the display is extremely good. Electronic paper consumes current only when changing the image, and its viewing angles are excellent. One advantage of the display in question is thus, among others, that it consumes electricity only when the optical state of the display is changed. A display element based on electronic paper can be formed to be very thin, in which case it can easily be arranged onto different installation surfaces or into different places.

### BRIEF DESCRIPTION OF THE FIGURES

In the following, the invention will be described in detail by the aid of some embodiments with reference to the attached drawings, wherein:

FIG. 1 presents a simplified view of one display apparatus according to the invention,

FIG. 2 presents a simplified view of one display apparatus according to the invention as a cross-section along the line II-II of FIG. 1,

FIG. 3 presents a detail from FIG. 2,

FIGS. 4, 5, 6 and 7 present the display apparatus showing some typical images,

FIGS. 8 (a), (b), (c), (d), (e), (f) present a display apparatus and some typical information items displayed by it, and

FIG. 9 presents a detail of a system according to the invention as a diagram.

### DETAILED DESCRIPTION OF THE INVENTION

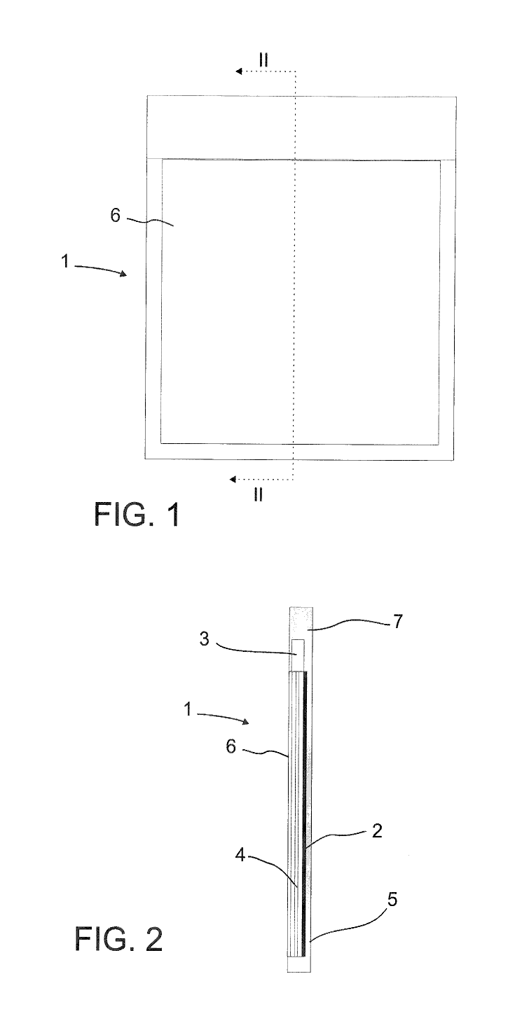

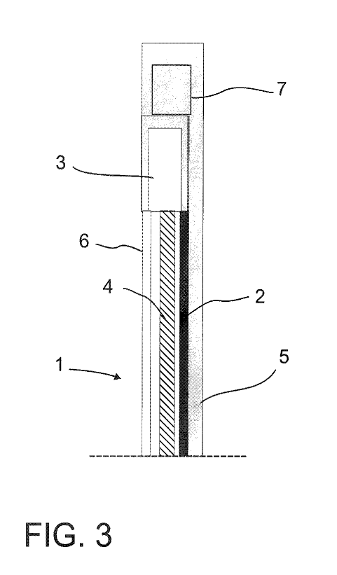

FIGS. 1 and 2 present an information display apparatus 1 according to an embodiment of the system of the invention. The display apparatus 1 comprises a display unit, which comprises a display element 2. The display element 2 is preferably so-called electronic paper, i.e. an e-paper display element, e.g. an electrophoretic display element. This and other corresponding types of display, and the manufacture of them, are described e.g. in publication WO 02/01281. Electronic paper is typically a thin, possibly flexible, display, which does not contain its own light source, but instead reflects external radiation. Its ink is between two electrode layers formed of different pixels. By changing the charge of a certain pixel by means of control electronics, the oil-like ink is made to pack against the surface of an electrode, in which case the color changes e.g. from white to black. Electronic paper consumes current only when changing the image and its viewing angles are excellent. One advantage of the display in question is thus, among others, that it consumes electricity only when the optical state of the display is changed. A display element based on electronic paper can be formed to be very thin, in which case it can easily be arranged onto different installation surfaces or into different places.

A property of a display based on e-paper is its opacity, in which case the conventional backlighting in flat displays, such as in liquid crystal (LCD) displays, cannot be used in it.

Owing to this fact, the display apparatus 1 according to the invention comprises a lighting arrangement of the display element 2, which lighting arrangement comprises at least one light source 3 as well as a photoconducting element 4, which is arranged above the display surface of the display element. The photoconducting element 4 is in the case according to the figure a layer, such as a film or corresponding. Some lighting arrangements, which are advantageously suited for use in connection with the display element of the invention, are presented in the publications WO 2005107363 and WO 0074026.

In the lighting arrangement, one or more light sources 3 are arranged to the side of the display element 2, in which case the light is conducted from the light source by means of the photoconducting element 4 to the front side of the display element 2. The one or more light sources 3 can be an applicable light source, e.g. a light-emitting diode (LED). Also other suitable types of light sources can be used.

The display apparatus 1 preferably comprises a transparent protective layer 6 to protect the display element. Typically a protective layer 6 is arranged on top of, or in front of, the photoconducting element 4 as seen from the direction of viewing the display apparatus. The protective layer can be of plastic or corresponding, e.g. acrylic, polycarbonate or corresponding, more particularly of material that withstands wear such as scratching and impacts.

The display apparatus comprises the necessary control means 7 of the display. The control means typically comprise a display controller, memory means for storing information data, such as image data, means for transmitting information data to the display controller and/or to the memory means. The display apparatus 1 can comprise means for connecting the display apparatus to a control system. Information can be transmitted to the display apparatus from the control system wirelessly and/or by wireline. In addition, the apparatus can comprise an accumulator or corresponding power source and/or a connection to an electricity network.

The display apparatus according to the invention is particularly suited to systems in which the image to be displayed on the screen is changed electrically with e-papers or corresponding according to the evacuation/guidance situation and in which an image can also be changed to another image.

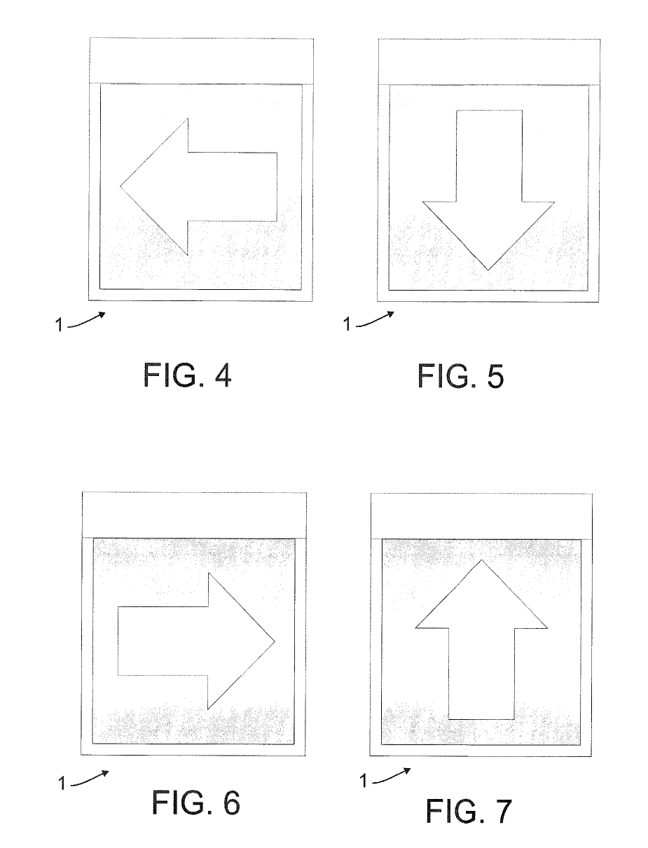

A film is installed on the surface of the display element, which film illuminates the display surface via the LED lights. The control of the display apparatus can be either with a fixed network or with a radio network. The image displayed by the display can be e.g. an arrow in different directions, a pictogram of a person and a door in different directions, various verbal messages such as Fire, etc. FIGS. 4-7 present arrows in different directions on the display of the display apparatuses 1. Thus, the guidance direction of the display apparatus can be changed according to the guidance situation or evacuation situation by changing the image displayed by the display element. The display can also comprise other colors, in which case the image shown by the display can be made to be clear. The contrast of an e-paper display, more particularly of an electrophoretic display, is extremely good, in which case the display can be made to be clear. In addition, when using an illumination arrangement of the display element, the prominence of the image or message displayed by the display apparatus can be further improved.

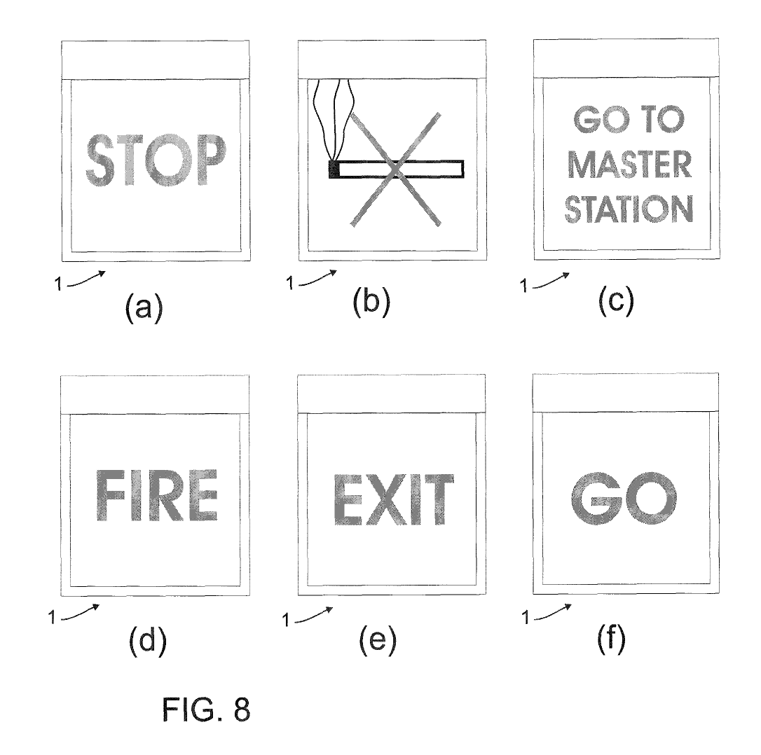

FIGS. 8 (a)-(f) further present some examples of messages displayed by the display apparatus on the display of the display apparatus, which messages can be applied in the system according to the invention. Very clear messages, either verbal messages and/or pictorial messages, can be given in the system. FIG. 8 (a) presents the word “STOP”, which urges the reader to stop. FIG. 8 (b) indicates a smoking prohibition with an image. FIG. 8 (c) gives the message “GO TO MASTER STATION”. In FIG. 8 (d) the word “FIRE” is on the display, which means a fire/fire alarm. In FIG. 8 (e) the word “EXIT” is on the display, which indicates the emergency exit. In FIG. 8 (f) the word “GO” is on the display, which urges the reader to go away.

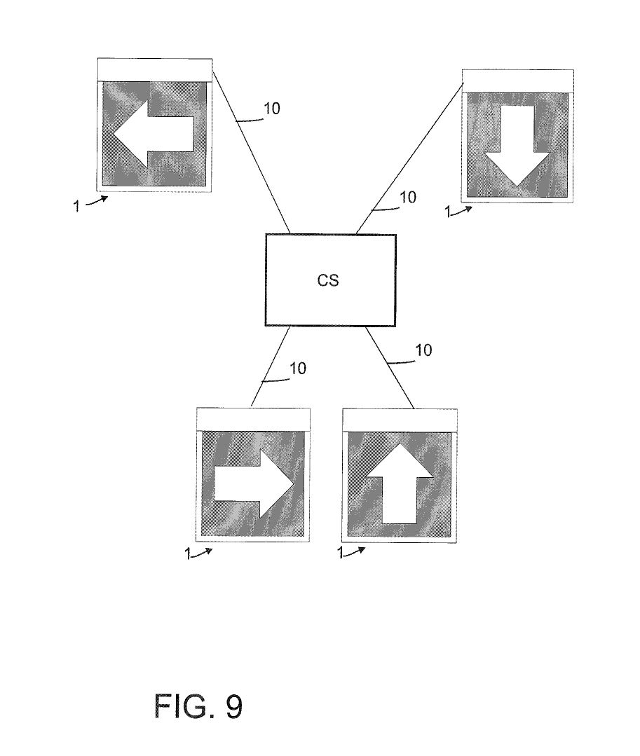

FIG. 9 presents as a diagram a detail of the system according to the invention. In it, a number of display apparatuses 1 are connected to a control system CS with a wireless or wireline connection 10. The wireless connection can be e.g. a radio-frequency connection or e.g. an infrared connection.

The invention thus relates to a display system for guiding, advising or evacuating, in which system people are guided, advised or warned with display means, such as with display apparatuses, which display apparatuses comprise information, such as images or signs. The display apparatus 1 comprises a display panel 2, which is an e-paper display, i.e. an electronic-paper display panel, such as an electrophoretic display panel or a display panel of that type, for which a lighting arrangement is arranged, which lighting arrangement comprises a light source 3 and a photoconductor layer 4 arranged on the display surface of the display panel or in front of it, which photoconductor layer is fitted to conduct the light of the light source to the display surface of the display panel.

According to one preferred embodiment the display apparatus 1 comprises control means 7, such as a display controller.

According to one preferred embodiment control information and/or display information is brought to the display apparatus 1 wirelessly or by wireline.

According to one preferred embodiment the display apparatus 1 comprises a memory means.

According to one preferred embodiment a number of displays images or information items are arranged in the memory means, and the display apparatus 1 can be connected to the control system CS, with which the image or information shown on the display can be selected.

According to one preferred embodiment the control system CS is an emergency exit guidance system, an evacuation system or a fire alarm system.

According to one preferred embodiment the control system CS is fitted to communicate with the memory means of the display apparatus 1 and to supply and/or to read information to the memory means/from the memory means.

According to one preferred embodiment the control system CS is fitted to control a number of display apparatuses 1.

According to one preferred embodiment the display apparatus 1 is fitted to switch from a first operating mode to a second operating mode on the basis of an indication of an emergency.

According to one preferred embodiment the display apparatus 1 is fitted to switch from a first operating mode to a second operating mode on the basis of an indication of fire.

According to one preferred embodiment the display apparatus 1 comprises an accumulator or corresponding power source.

According to one preferred embodiment the display apparatus 1 can be connected with a wireless connection and/or with a wireline connection 10 to the control system CS.

The invention also relates to a display apparatus 1 for controlling a system, for advising or evacuating, in which system people are guided, advised or warned with display means, such as with display apparatuses, which display apparatuses comprise information, such as images or signs, which display apparatus 1 comprises a display panel 2 and also means for lighting the display panel. The display panel 2 is an e-paper display, i.e. an electronic-paper display panel, such as an electrophoretic display panel or a display panel of that type, for which a lighting arrangement is arranged, which lighting arrangement comprises a light source 3 and a photoconductor layer 4 arranged on the display surface of the display panel 2 or in front of it, which photoconductor layer is fitted to conduct the light of the light source 3 to the display surface of the display panel.

According to one preferred embodiment the display apparatus 1 comprises control means 7, such as a display controller.

According to one preferred embodiment the display apparatus 1 is fitted to receive control information and/or display information wirelessly or by wireline.

According to one preferred embodiment the display apparatus 1 comprises a memory means.

According to one preferred embodiment a number of display images or information items are arranged in the memory means, and the display apparatus 1 can be connected to the control system CS, with which the image or information shown on the display can be selected.

According to one preferred embodiment the display apparatus 1 is fitted to receive information from the control system CS, which is an emergency exit guidance system, an evacuation system or a fire alarm system.

According to one preferred embodiment the control system CS is fitted to communicate with the memory means of the display apparatus 1 and to supply and/or to read information to the memory means/from the memory means.

According to one preferred embodiment the control system CS is fitted to control a number of display apparatuses 1.

According to one preferred embodiment the display apparatus 1 is fitted to switch from a first operating mode to a second operating mode on the basis of an indication of an emergency.

According to one preferred embodiment the display apparatus 1 is fitted to switch from a first operating mode to a second operating mode on the basis of an indication of fire. In the first operating mode the display can display some other information and in the second operating mode the display shows emergency exit information or other alarm information. The display information can be information given by a dynamic emergency exit guidance system, in which case in the second operating mode the display is arranged to show an image or other information suited to the situation.

According to one preferred embodiment the display apparatus 1 comprises an accumulator or corresponding power source.

According to one preferred embodiment the display apparatus 1 can be connected with a wireless connection and/or with a wireline connection 10 to the control system CS.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Display system for guiding, advising or evacuating, in which system people are guided, advised or warned with display means, such as with display apparatuses, which display apparatuses comprise information, such as images or signs,
characterized in that the display apparatus (1) comprises a display panel (2), which is an e-paper display, such as an electrophoretic display panel or a display panel of that type, for which a lighting arrangement is arranged, which lighting arrangement comprises a light source (3) and a photoconductor layer (4) arranged on the display surface of the display panel or in front of it, which photoconductor layer is fitted to conduct the light of the light source to the display surface of the display panel.

2. System according to claim 1, characterized in that the display apparatus (1) comprises control means (7), such as a display controller.

3. System according to claim 1, characterized in that control information and/or display information is brought to the display apparatus (1) wirelessly or by wireline.

4. System according to claim 1, characterized in that the display apparatus (1) comprises a memory means.

5. System according to claim 1, characterized in that a number of display images or information items are arranged in the memory means, and the display apparatus (1) can be connected to a control system (CS), with which the image or information shown on the display can be selected.

6. System according to claim 1, characterized in that the control system (CS) is an emergency exit guidance system, an evacuation system or a fire alarm system.

7. System according to claim 1, characterized in that the control system (CS) is fitted to communicate with the memory means of the display apparatus (1) and to supply and/or to read information to the memory means/from the memory means.

8. System according to 1, characterized in that the control system (CS) is fitted to control a number of display apparatuses (1).

9. System according to claim 1, characterized in that the display apparatus (1) is fitted to switch from a first operating mode to a second operating mode on the basis of an indication of an emergency.

10. System according to claim 1, characterized in that the display apparatus (1) is fitted to switch from a first operating mode to a second operating mode on the basis of an indication of fire.

11. System according to claim 1, characterized in that the display apparatus (1) comprises an accumulator or corresponding power source.

12. System according to claim 1, characterized in that the display apparatus (1) can be connected with a wireless connection and/or with a wireline connection (10) to the control system (CS).

13. Display apparatus (1) for controlling a display system, for advising or evacuating, in which system people are guided, advised or warned with display means, such as with display apparatuses, which display apparatuses comprise information, such as images or signs, which display apparatus (1) comprises a display panel (2) and also means for lighting the display panel, characterized in that the display panel (2) is an e-paper display, such as an electrophoretic display panel or a display panel of that type, for which a lighting arrangement is arranged, which lighting arrangement comprises a light source (3) and a photoconductor layer (4) arranged on the display surface of the display panel (2) or in front of it, which photoconductor layer is fitted to conduct the light of the light source (3) to the display surface of the display panel.

14. Display apparatus according to claim 13, characterized in that the display apparatus (1) comprises control means (7), such as a display controller.

15. Display apparatus according to claim 13, characterized in that the display apparatus (1) is fitted to receive control information and/or display information wirelessly or by wireline.

16. Display apparatus according to claim 13, characterized in that the display apparatus (1) comprises a memory means.

17. Display apparatus according to claim 16, characterized in that a number of display images or information items are arranged in the memory means, and the display apparatus (1) can be connected to the control system (CS), with which the image or information shown on the display can be selected.

18. Display apparatus according to claim 13, characterized in that the display apparatus is fitted to receive information from the control system (CS), which is an emergency exit guidance system, an evacuation system or a fire alarm system.

19. Display apparatus according to claim 13, characterized in that the control system (CS) is fitted to communicate with the memory means of the display apparatus (1) and to supply and/or to read information to the memory means/from the memory means.

20. Display apparatus according to claim 13, characterized in that the control system (CS) is fitted to control a number of display apparatuses (1).

21. Display apparatus according to claim 13, characterized in that the display apparatus (1) is fitted to switch from a first operating mode to a second operating mode on the basis of an indication of an emergency.

22. Display apparatus according to claim 13, characterized in that the display apparatus (1) is fitted to switch from a first operating mode to a second operating mode on the basis of an indication of fire.

23. Display apparatus according to claim 13, characterized in that the display apparatus (1) comprises an accumulator or corresponding power source.

24. Display apparatus according to claim 13, characterized in that the display apparatus (1) can be connected with a wireless connection and/or with a wireline connection (10) to the control system (CS).
